(19) United States
(12) Patent Application Publication
(10) Pub. No.: US 2026/0298692 A1
(43) Pub. Date: Oct. 1, 2026

(54) HUB CAP WITH OIL LEVEL INDICATOR

(71) Applicant: Aperia Technologies, Inc., Hayward, CA (US)

(72) Inventors: Kristen Apostol, Hayward, CA (US); Kevin Ciocia, Burlingame, CA (US)

(73) Assignee: Aperia Technologies, Inc., Hayward, CA (US)

(21) Appl. No.: 19/629,995

(22) Filed: Mar. 26, 2026

Related U.S. Application Data
(60) Provisional application No. 63/779,103, filed on Mar. 27, 2025.

(51) Int. Cl. G01F 23/76; G01F 23/02; G01F 23/32; G01F 23/34

(52) U.S. Cl. CPC G01F 23/76; G01F 23/02; G01F 23/32; G01F 23/34

(57) ABSTRACT

Aspects of the invention(s) described include: a system including: a hub cap including a central axis defining a rotational axis for the system; an indicator window including an indicator portion coaxially aligned with the central axis; and an indicator subsystem. A variation of the system can include an indicator subsystem with a float mechanism defining an indicator resolution; a shaft aligned with the central axis, wherein a first float of the float mechanism rotates about the shaft and wherein the first float includes a first lobe, a first counterweight, and a marking; and a mask defining an opening through which the marking can be observed. The invention(s) allow oil level within an oil reservoir of a hub cap to be observed, even when an inflator is interfaced with the hub cap for inflating a tire of an associated wheel.

### CROSS-REFERENCE TO RELATED APPLICATIONS

This application claims the benefit of US Provisional Application number 63/779,103 filed 27-MAR-2025, which is incorporated in its entirety by this reference.

### TECHNICAL FIELD

This invention relates generally to the automotive field, and more specifically to a new and useful hub cap in the automotive field.

### BRIEF DESCRIPTION OF THE SEVERAL VIEWS OF THE DRAWINGS

FIG. 1 is a view of a variant of the hub cap mounted to a wheel and an inflator 5 configured to mount over the hub cap.

FIG. 2A is an exploded view of a first variant of the hub cap.

FIG. 2B is a front view of the variant shown in FIG. 2A.

FIG. 2C is a side view of the variant shown in FIG. 2A.

FIG. 2D is an exploded view of a second variant of the hub cap with multiple floats.

FIG. 2E is a front view of the variant shown in FIG. 2D.

FIG. 3A is an isometric view of a variant of the system that includes a neck.

FIG. 3B is a cross-sectional view of the variant shown in FIG. 3A.

FIG. 4A is a front view of a first variant of a float.

FIG. 4B is a front view of a second variant of a float.

FIG. 4C is a back view of the second variant of the float.

FIG. 4D is an illustrative example of a static mask with a set of radially opposing openings that allow a section of the rotating float to show therethrough.

FIG. 5A is an illustrative example of variant of a float mechanism at two different oil levels.

FIG. 5B is a photographic example of a variant with a rotating float that changes pose angles between different fill states.

FIG. 6 is a front view of a variant of an inflator 5 mounted over the hub cap on a wheel.

FIG. 7 is an isometric view of a variant of the hub cap.

### DETAILED DESCRIPTION OF THE INVENTION

The following description of the embodiments of the invention is not intended to limit the invention to these embodiments, but rather to enable any person skilled in the art to make and use this invention.

In variants, the hub cap 110 can include: a housing; and an oil level indicator. The hub cap 110 functions to allow for visualization of oil levels while the oil level is obscured (e.g., when a tire inflator 5 is attached over the hub cap 110 to the wheel 10).

In an illustrative example, variants of the system can include a hub cap 110, an oil reservoir positioned within the hub cap, an indicator window 120 mountable to the hub cap, and an indicator subsystem 200 arranged within the hub cap 110 and viewable through the indicator window 120. The indicator subsystem 200 can include a float mechanism 210, mask 220, and shaft 230. The float mechanism can include two floats, each float 211 including a lobe 2111 and counterweight 2112. The float mechanism is mounted to face the indicator window 120 via the shaft 230, which is coaxially aligned with the center of the indicator window 120, mask 220, and float mechanism 210. Each float 211 is rotatable about the shaft 230 and changes angular position based on the oil level in the reservoir. The first float 211 can include a set of markings 2113 (e.g., green and red markings 2113) arranged radially around the center of the float 211 and configured to indicate the oil level of the reservoir (e.g., full or empty, an intermediate position between full and empty, etc.). The second float 211 can include the mask 220 defining a plurality of openings. The second float 211 rotates with respect to the first float 211 (e.g., independently in relation to the first float) and the mask 220 selectively reveals the oil level markings 2113 on the first float 211 based upon an amount of oil present within the oil reservoir.

### 1. System

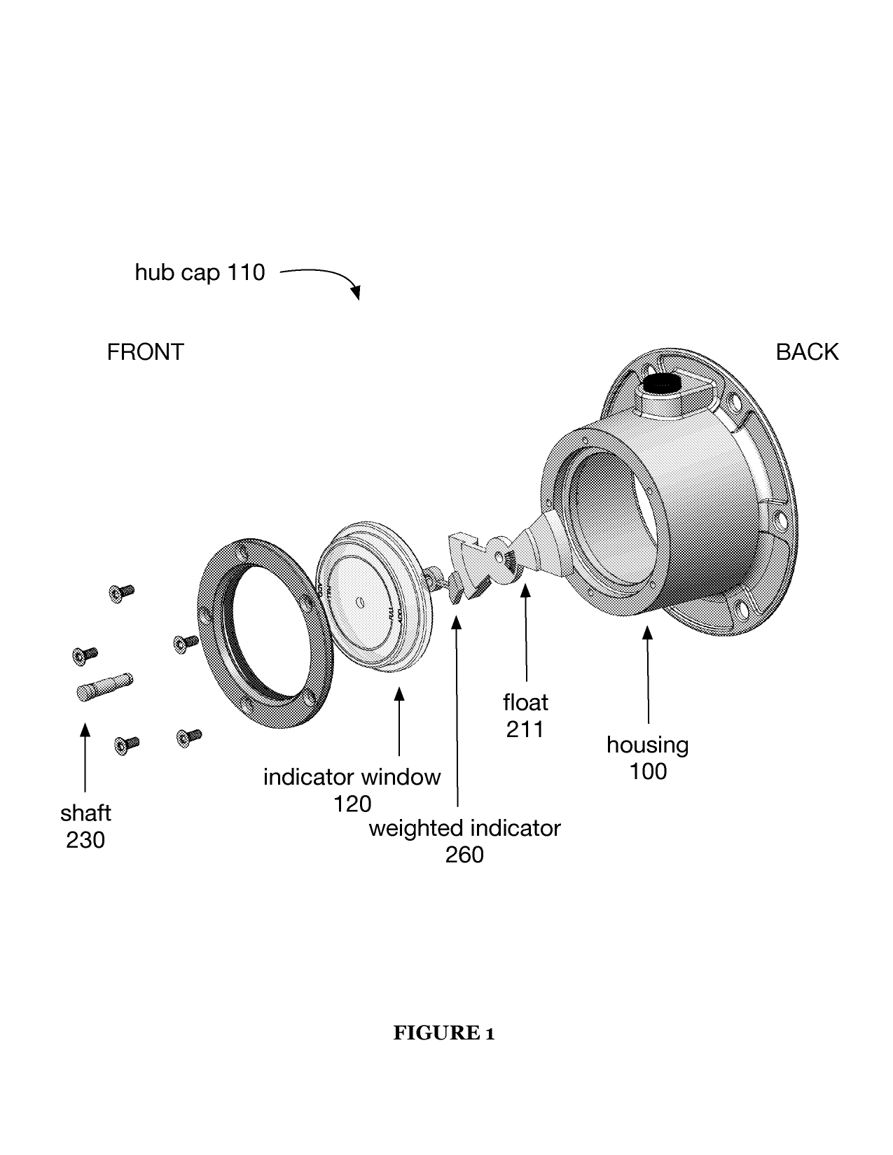

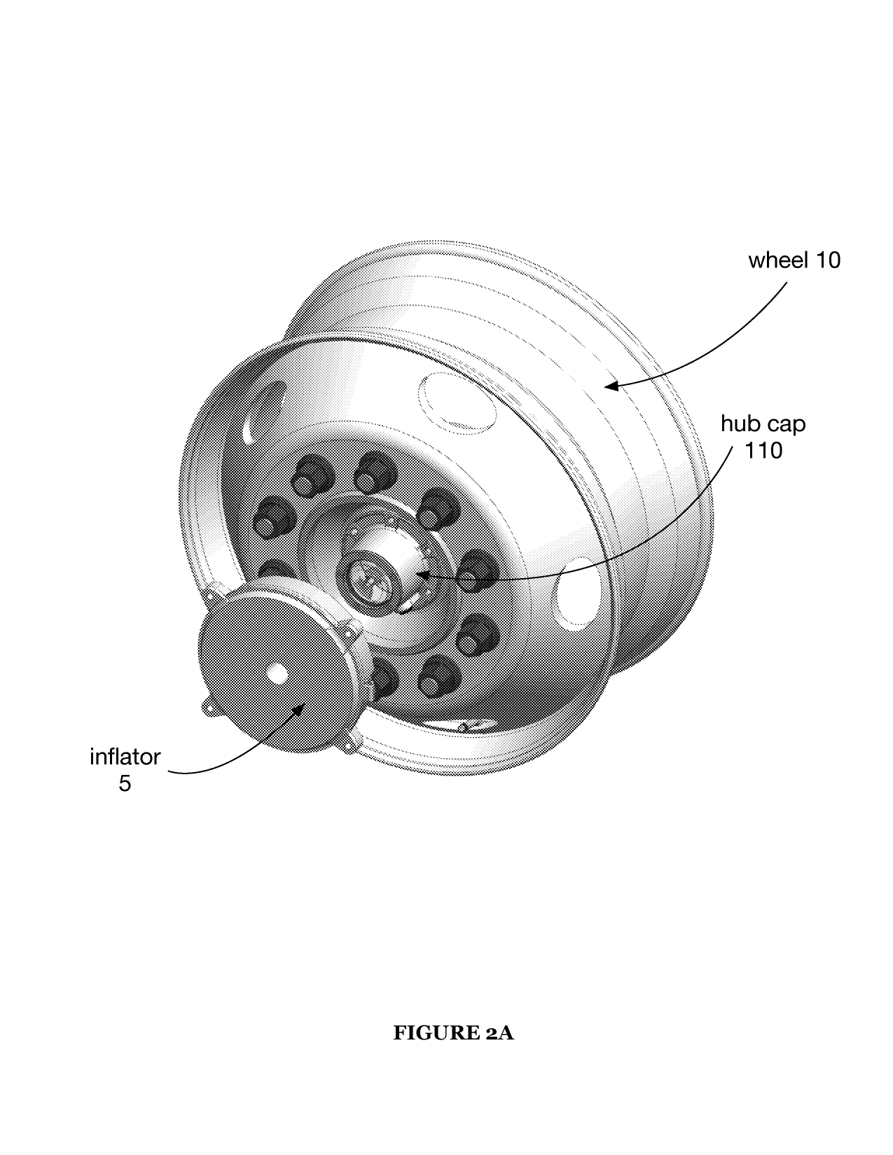

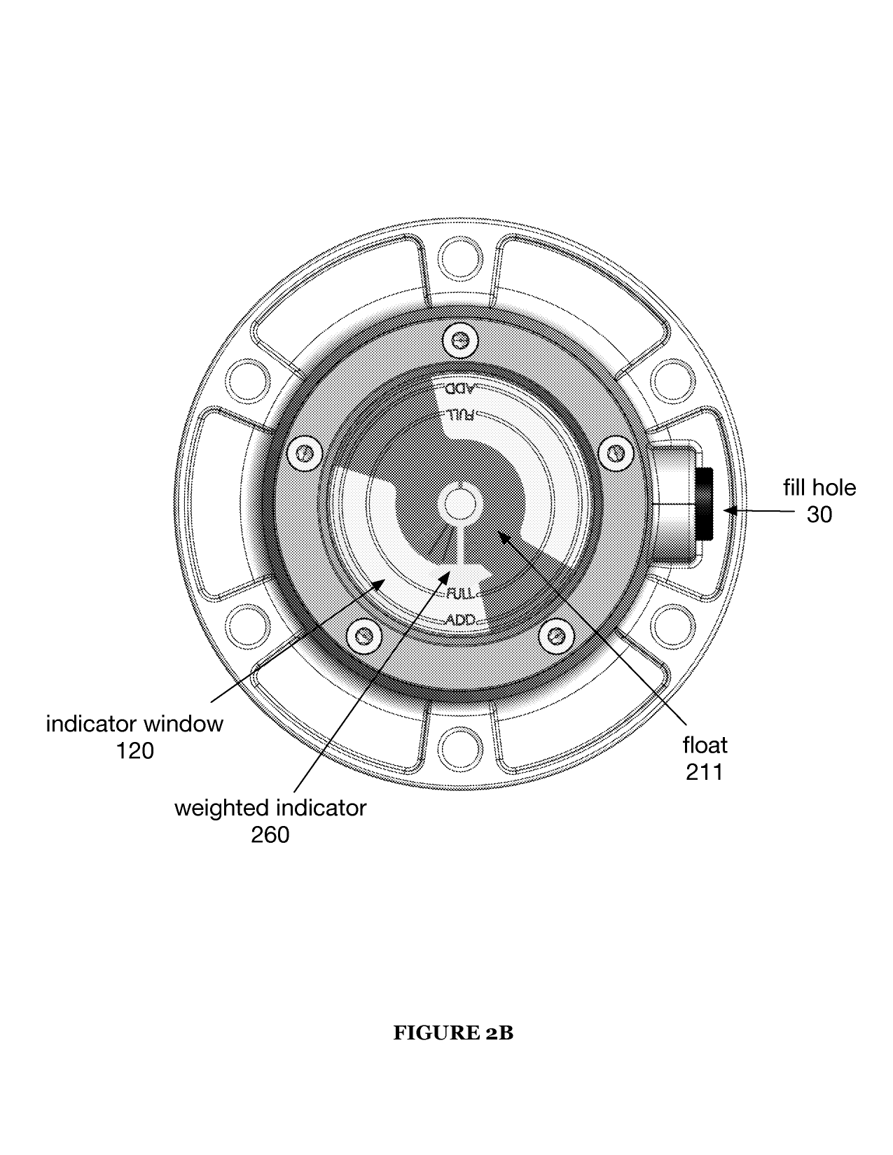

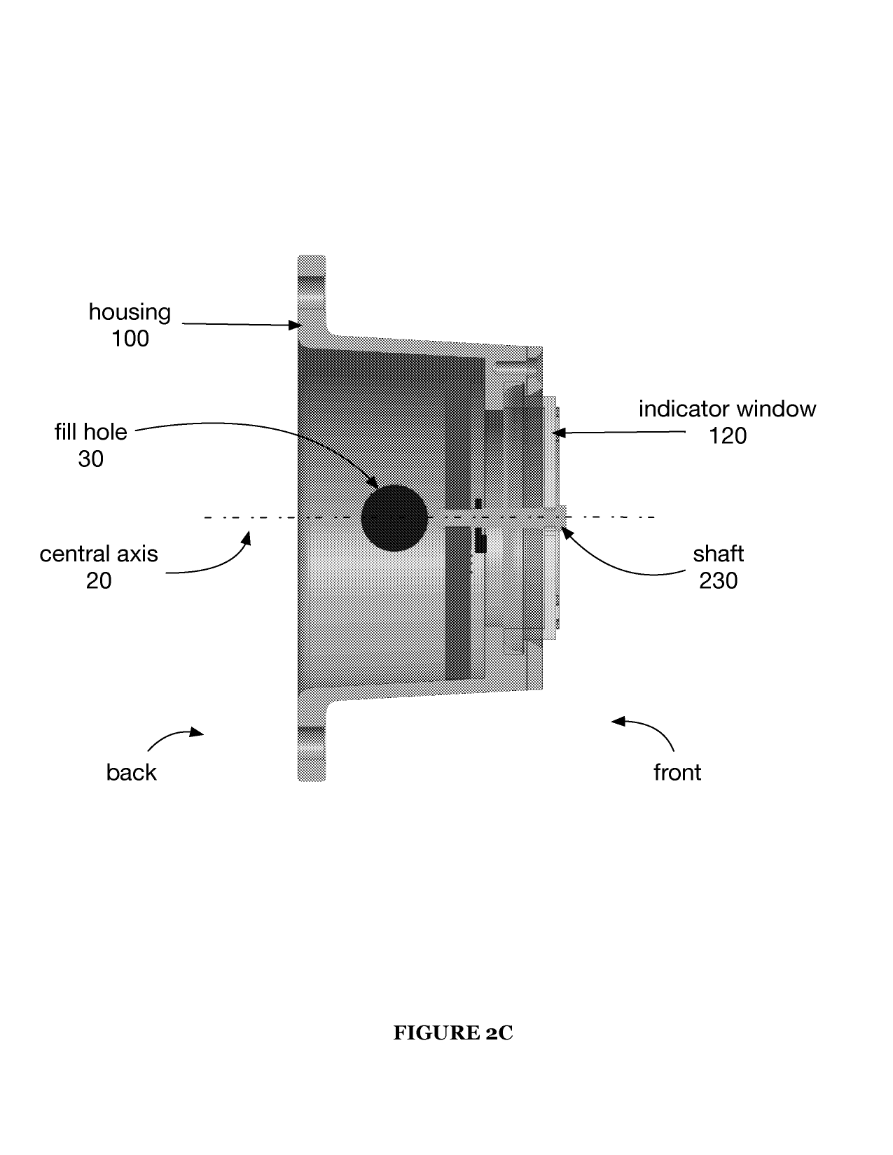

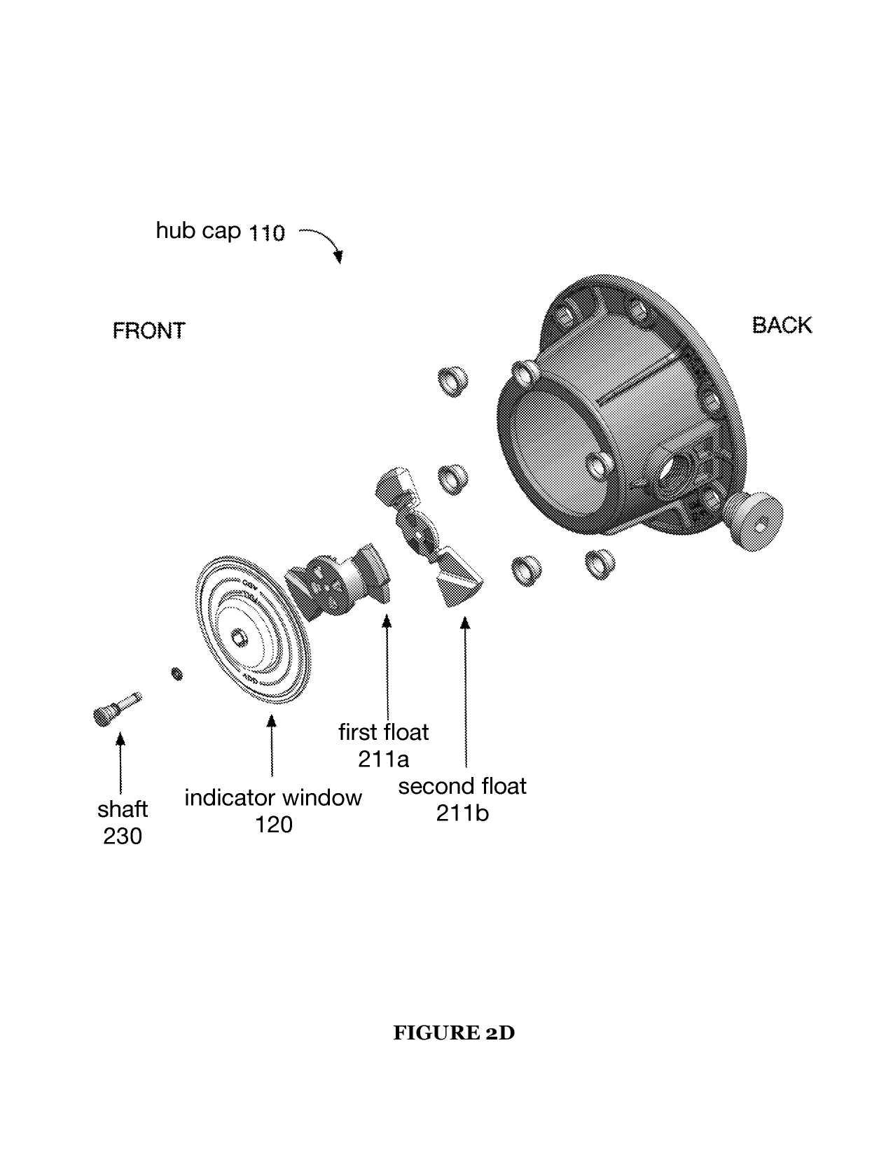

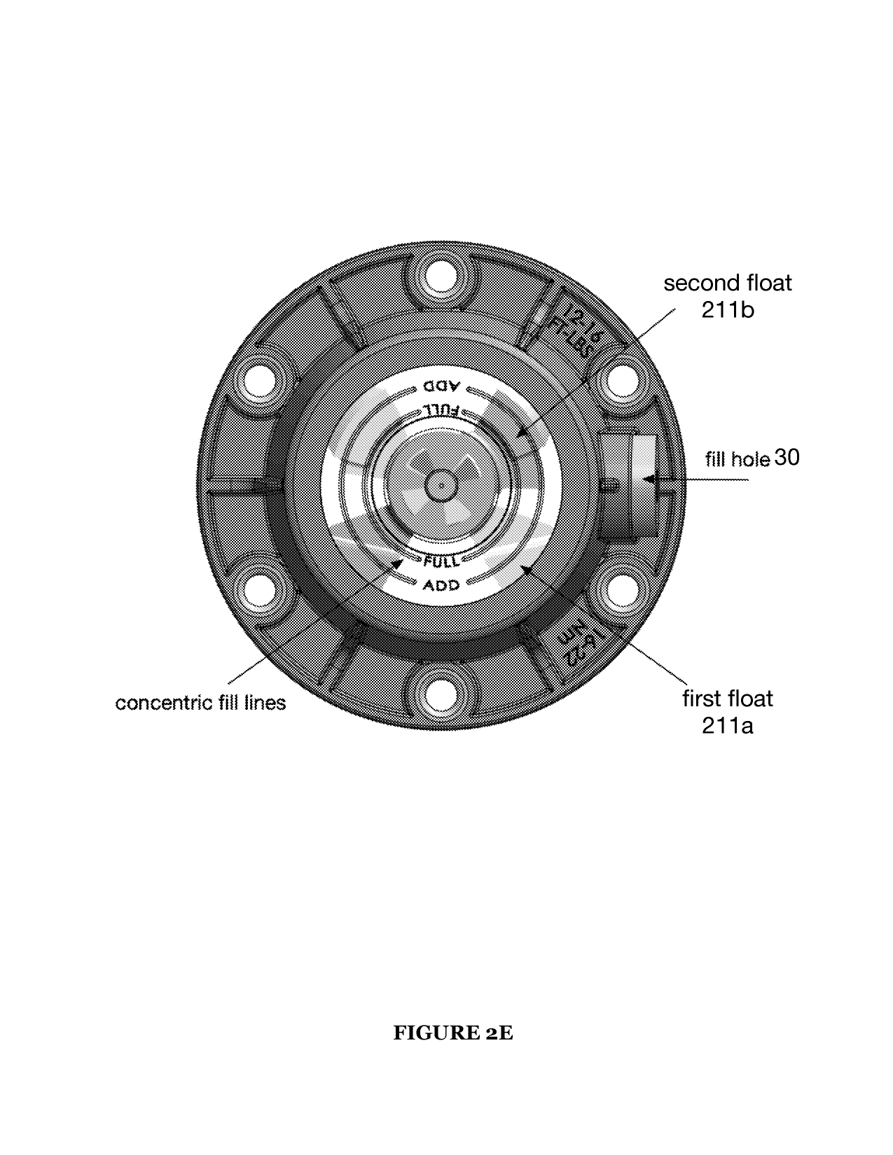

As shown in FIGS. 1 and 2D, the hub cap 110 system with housing 100 functions to allow for visualization of oil levels, where traditional hub cap 110 oil level indicators are obstructed by other components (e.g., tire inflators, etc.). The system preferably mounts to the hub of a wheel (e.g., example shown in FIGS. 1 and 2D), but can alternatively mount to any other suitable location. The wheel is preferably a wheel on a steering axle, but can alternatively be a wheel on a drive axle, tractor axles, trailer axles, and/or other axles.

### 1.1 System – Supporting elements

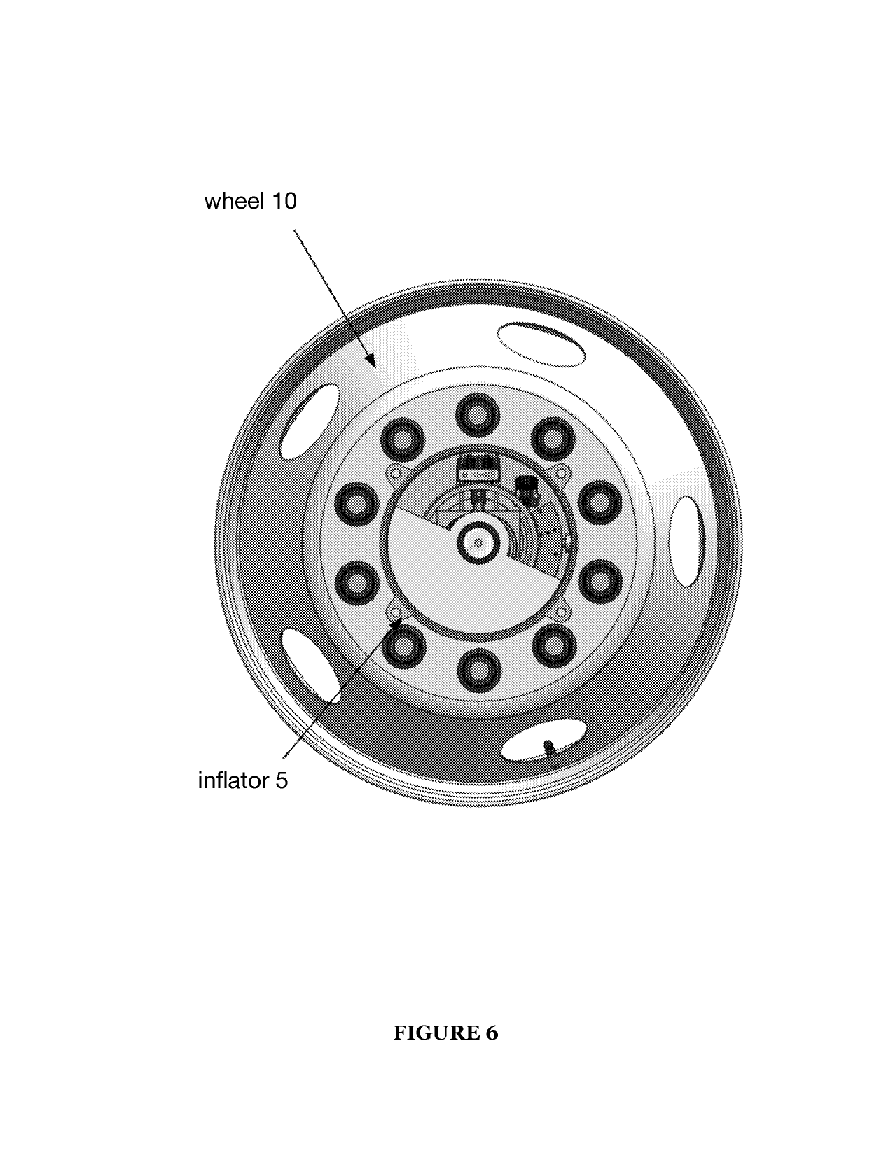

The hub cap 110 can be used with or accommodate an inflator. The inflator 5 can function to inflate the tire mounted to the wheel. The inflator 5 preferably mounts over a portion of the hub cap 110 (e.g., over the oil settling region along the perimeter of the hub cap), examples shown in FIGS. 1 and 6, but can alternatively otherwise mount to the wheel (e.g., to the hub, using wheel studs, etc.). The inflator 5 can include: an inflator 5 housing 100 mountable to the wheel; and a pump with a pump body statically mounted to the inflator 5 housing 100 and a piston actuatable relative to the pump body. The pump can have a first end (e.g., big end) with a symmetric or asymmetric bore. The inflator 5 can further include a hanging mass freely rotatable relative to the inflator 5 housing; and an asymmetric cam statically mounted to the hanging mass and engaging the first end (e.g., big end) of the piston; wherein relative motion between the housing 100 and the hanging mass drives piston actuation relative to the pump body. However, the inflator 5 can be otherwise configured. The inflator 5 can be any of the inflators disclosed in US Application No. 14/839,009 filed 28-AUG-2015, US Application No. 18/538,645 filed 13-DEC-2023, US Application No. 18/535,939 filed 11-DEC-2023, each of which is incorporated herein by this reference in its entirety, and/or any other wheel-end inflator. In variants, the inflator 5 housing 100 and cam can define a bore therethrough. The bore can be 0.75", 1", 2", 3", and/or any other size. The bore can be coaxial with the rotational axis or offset from the rotational axis. The inflator 5 can be shaped as an annulus, disc, and/or any other shape.

The inflator 5 preferably mounts to the wheel (e.g., as shown in the example of FIG. 2A), which shows how the inflator would obstruct observation of traditional hub caps, but can alternatively be mounted elsewhere. For instance, the inflator 5 can fit over the housing, can alternatively mount to the housing, or can alternatively be mounted elsewhere.

### 1.2 System – Housing

The housing 100 functions to seal against the hub and define an oil reservoir, and to create a sealed environment for oil. The housing 100 can bolt, clip, or otherwise mount to the wheel hub.

In variants, the housing 100 includes a hub cap 110 body; a hub cap 110 front; and optionally a top up assembly (e.g., center fill assembly) with a vent, which functions to vent the oil reservoir (e.g., during refilling of oil, during operation of the vehicle associated with the hub cap, etc.).

The hub cap 110 body can define a back (e.g., configured to seal against the hub), a front opposing the back, and a set of side walls extending between the back and front, and/or other components. The back of the hub cap 110 body can define flanges, threads, hub mounting points, and/or any other features.

The front of the hub cap 110 body can be open (e.g., such that the body defines a tube) or capped (e.g., such that the hub cap 110 body is closed). Alternatively, the front of the hub cap 110 body can be partially open or partially closed and/or have any other suitable characteristics.

The walls of the hub cap 110 body can cooperatively define a body that is cylindrical, conic, cylindrical with drafted walls, and/or any other shape. The walls of the hub cap 110 body can further surround or otherwise define a central axis 20 which extends from the front (e.g., opening) to the back (e.g., hub mounting points) of the hub cap 110 body. Alternatively, the central axis can be defined using any other suitable elements of the hub cap 110 body. As such, the hub cap 110 can include a central axis defining a rotational axis for the system.

The hub cap 110 body can be made of aluminum, steel, plastic, titanium, and/or any other material. The hub cap 110 body can be a standard oil hub cap size (e.g., between a 4-1/2" to 6-3/4" bolt circle, etc.), be smaller than a standard oil hub cap (e.g., in the front, in the back, etc.), and/or otherwise sized.

The hub cap 110 body can define a fill hole 30 (an example of which is shown in FIG. 2B). The fill hole can be used for adding oil to the oil reservoir within the hub cap. The fill hole can be located on the walls of the hub cap 110 body and/or otherwise located. The fill hole can be plugged using a fill hole plug, or otherwise sealed. The fill hole plug can be: a threaded plug, rubber vent plug, magnetic plug, an ESP plug, and/or be any other plug type.

The hub cap 110 body can include a wheel hub interface. The wheel hub interface can be located at the back of the hub cap 110 body and/or otherwise located. Alternatively, the wheel hub interface can extend from a side wall of the hub cap 110 body and/or have another suitable location. In a first variant, the hub cap 110 body can include flanges on housing 100 for bolting to wheel hub assembly. The flanges can be weld neck flanges, slip-on flanges, blind flanges, threaded flanges, socket weld flanges, or other suitable types of flanges. In a second variant, the hub cap 110 body can include threads on the housing 100 that provide a mechanism for a screw-in interface with the wheel hub assembly.

However, the hub cap 110 body may be otherwise configured.

The hub cap 110 front includes an indicator window 120, which functions to cooperatively form an oil reservoir with the hub cap 110 body, and provide visual access to the oil level inside the hub cap 110 body. The indicator window 120 can also function to seal the hub cap, cooperatively form a sealed fluid volume with the hub cap, and provide visual access to the oil level inside the hub cap. The hub cap 110 front/indicator window 120 is preferably removably mounted (e.g., clipped, bolted, screwed, etc.) to the front of the hub cap 110 body, but can alternatively be formed as a unitary piece with the hub cap 110 body.

In a first variant, the indicator window 120 (e.g., examples shown in FIGS. 2A, 2B and 2C) can provide direct visual access to the oil level within the hub cap 110 body. The indicator window 120 is preferably clear or translucent, but can alternatively have any other visual transmittance. The window can be made of plastic, glass, and/or any other material. In variants, the window can include an interior coating. The interior coating can function to prevent fouling and/or dirt buildup on the window interior. The interior coating can include: oleophobic and/or low surface energy materials, and/or any other coating materials. Examples of coating materials that can be used include: PTFE, fluoropolymer-based coatings, titanium dioxide coatings, and/or any other coating materials. In variations, the indicator window 120 can be composed of a material or coated with a material that is resistance to damage resulting from ultraviolet (UV) light exposure.

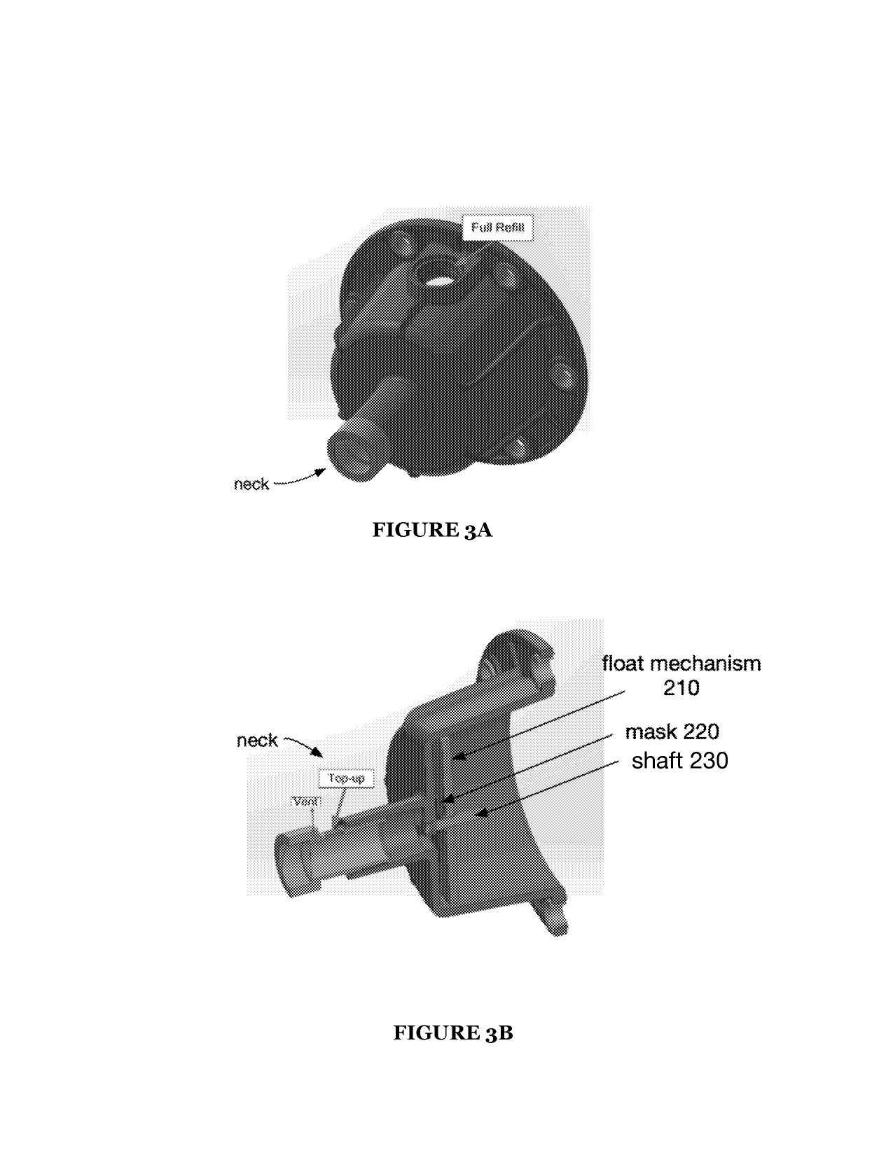

In a second variant, the hub cap 110 front can define a neck (e.g., examples of which are shown in FIG. 3A, FIG. 3B). The neck can extend through a bore defined through the inflator. The neck can be located at the front surface of housing, with the central axis aligned with the central axis of hub cap 110 body (e.g., coaxially aligned with the housing 100 body, coaxially aligned with a wheel rotational axis, etc.), but can alternatively be offset from the hub cap 110 body central axis. The neck geometry can be cylindrical, conic, and/or have any other geometry. The neck can be part of housing 100 and/or a separate component. The neck can optionally include a sight glass for viewing the oil level indicator (e.g., through the indicator window 120, in relation to the markings 2113of the first float 211 and/or the mask 220 of the second float 211 described in more detail below). The sight glass can be a magnifying lens and/or any other type of sight glass. The sight glass can be attached via a threaded lens holder and/or any other attachment method.

The indicator window 120 can include an indicator portion. The indicator portion can overlap with the central axis described above. In variations, the indicator portion can include one or more of: a set of concentric fill lines (e.g., as in the example shown in FIG. 2B), where an example includes a label “Add” marked at the outer circle and a label “Full” marked at the inner circle; a sensor, a set of numbers, horizontal hash marks, parallel lines (e.g., horizontal lines, concentric lines); binary markings 2113(e.g., full or empty labels), frosted regions, other types of gage markings 2113, and/or other suitable indicator portion markings 2113.

In variations, the indicator portion can be located on the window of the hub cap 110 cover. The indicator portion can alternatively be positioned proximal the perimeter of the indicator window 120 in order to be viewable when part of the hub cap 110 body is obstructed from view (e.g., during inflation of a tire with an inflator). The indicator portion can be alternatively positioned distal the window perimeter. The indicator portion can alternatively be a separate element which is attached to the window. The indicator portion can alternatively be otherwise located.

However, the hub cap 110 front and/or indicator window 120 may be otherwise configured.

The hub cap 110 can optionally include a top up assembly (e.g., center fill assembly), which functions to vent the oil reservoir (e.g., during oil refill), allowing the user to top off oil in hub cap 110 via an access point (e.g., in front portion of the hub cap, in a side wall of the hub cap, etc.). The top up assembly (e.g., center fill assembly) is thus preferably located in the hub cap 110 front, but can alternatively be located in a sidewall. The top up assembly can be located at the neck, indicator window 120, and/or any other suitable location.

The top up assembly (e.g., center fill assembly) can include a top up port and top up plug (e.g., a threaded plug, press-fit plug, etc.), and/or be otherwise configured. In a specific example, the top up assembly can include a threaded plug that extends through a threaded port defined through the center of the neck of the hub cap, wherein the top up plug can define a fluid inlet in a sidewall that is fluidly connected through the body of the threaded plug to the oil reservoir. Alternatively, the system can include a side port configured for oil filling.

However, the top up assembly (e.g., center fill assembly) may be otherwise configured, and the housing 100 may be otherwise configured to provide functionality for viewing indicated oil levels without obstruction, providing a sealed oil reservoir, allowing venting of a sealed oil reservoir, and/or serving other suitable functions.

### 1.3 System – Float Indicators

The system can further include an indicator subsystem 200, which functions to produce indications of an amount of oil remaining within the oil reservoir, where the indications can be observed through the indicator window 120 described above. In various scenarios, the indicator subsystem 200 can display oil levels while inflator 5 is mounted to the hub cap, when the inflator 5 is not connected to the hub cap, and/or in any other inflator 5 state.

As mentioned in the illustrated example above and elsewhere, the oil level indicator can be located within the housing, partially within housing, outside the housing 100 (e.g., connected to a float 211 inside the housing), and/or in any other location relative to the housing. The indicator subsystem 200 preferably includes a fill level indicator positioned proximal a center of the hub cap 110 cover (e.g., within 0.75", 1", 2", 3", and/or a range bounded by any of the aforementioned values of the cover center), such that the fill level indicator can be observed through the bore in the inflator. Alternatively, the fill level indicator can be positioned proximal a perimeter of the hub cap 110 cover, and/or be otherwise located.

The indicator subsystem 200 preferably displays oil levels at a point radially inward of the oil settling region (e.g., adjacent the perimeter of the hub cap 110 body), but can additionally or alternatively display oil levels at the oil settling region, or at any other location of the hub cap 110 body. The oil level indicator can display oil levels while the inflator 5 is mounted to the hub cap, when the inflator 5 is not connected to the hub cap, and/or in any other inflator 5 state.

The indicator subsystem 200 can be mounted coaxially with the central axis of the housing, rotational axis of the wheel, and/or any other axis. The indicator subsystem 200 can alternatively be mounted offset from the housing 100 central axis.

In embodiments, the indicator subsystem 200 is preferably mounted to the hub cap 110 cover, but can alternatively be mounted to the hub cap. In a first variant, the indicator subsystem 200 can be mounted in alignment with the center of the window (e.g., rotatably positioned along the shaft 230 aligned with a central axis of the hub cap 110 body). In a second variant, the indicator subsystem 200 can be mounted to the base of the neck of the system.

One or more components of the indicator subsystem 200 described in further detail below can include a polarized material (e.g., material configured to selectively block or reveal underlying indicia based on angular positions), a UV resistant material, coatings (e.g., to prevent oil buildup), and/or any other materials that provide sustained suitable performance. For instance, the indicator subsystem 200 can include portions with a polarized material configured to selectively block or reveal the marking 2113 of a float (described in more detail) based on the angular position of the float mechanism.

In embodiments, the indicator subsystem 200 includes a float mechanism 210 , which functions to float 211 based upon buoyancy of a portion of the float mechanism within the oil of the oil reservoir, where an equilibrium float 211 position is indicative of the oil level, and where the equilibrium float 211 position provides an indication of oil level based upon markings 2113 positioned on a portion of the float mechanism 210.

### 1.3.1 Float 211 – Lobe 2111 and Counterweight 2112 Aspects

The float mechanism can include any number of floats (e.g., one, two, three, four, five, six, seven, eight, nine, ten, or more). In the example shown in FIG. 2D, the float mechanism includes two floats.

Each float 211 included in the float mechanism can be identical (e.g., with the same dimensions, with the same morphological profile, composed of the same material, having the same weight, etc.). Alternatively, each float 211 can have different characteristics (e.g., with different dimensions, with different morphological profiles, composed of different materials, having different weights, etc.).

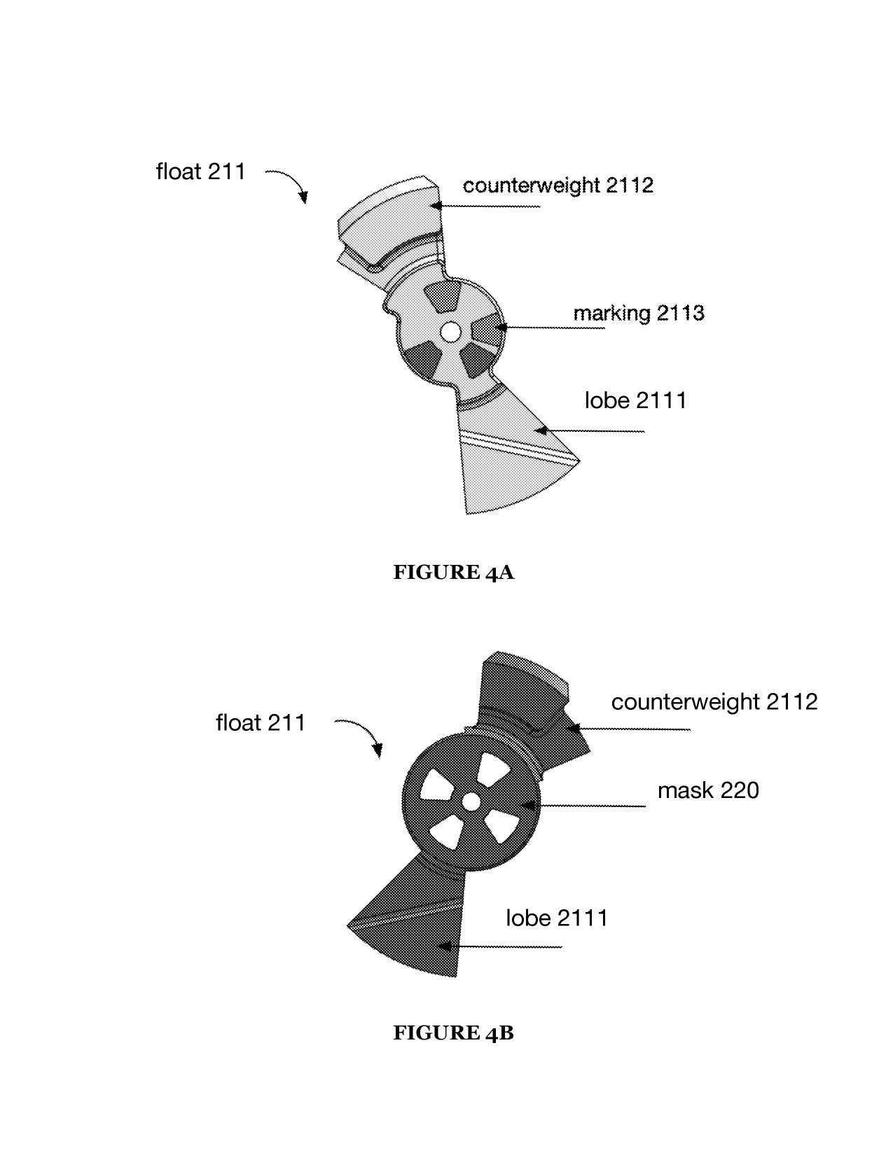

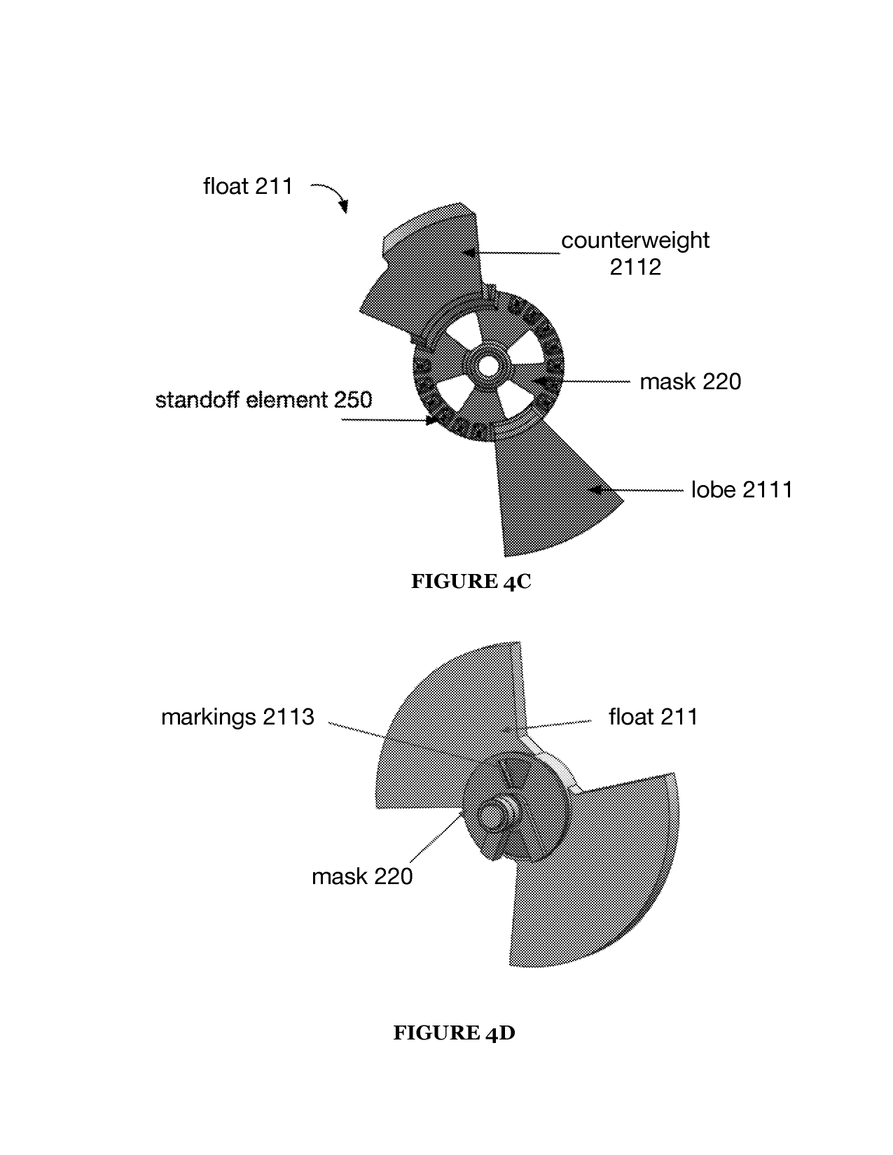

The float mechanism can define an indicator resolution, based, for instance, on the number of floats and a range of rotation provided by each float 211 of the float mechanism 210. The indicator resolution can be defined by the rotational movement of a float, the angular displacement between multiple floats about the central axis, the minimum angular rotation of one float, and/or any other defining factor. As such, including additional floats to the float mechanism can further define the indicator resolution. In examples, adding additional floats to the float mechanism can increase the indicator resolution along a linear scale (e.g., the float mechanism having two floats can double the indicator resolution) or non-linear scale. Alternatively, adding additional floats can decrease the indicator resolution and/or have any other suitable impact on the indicator resolution. In embodiments, inclusion of a second float 211b, as shown in FIGS. 4A-4D, can increase indicator resolution by at least a factor of 2.

The float mechanism can include components composed of plastic, metal, composite, and/or any other material.

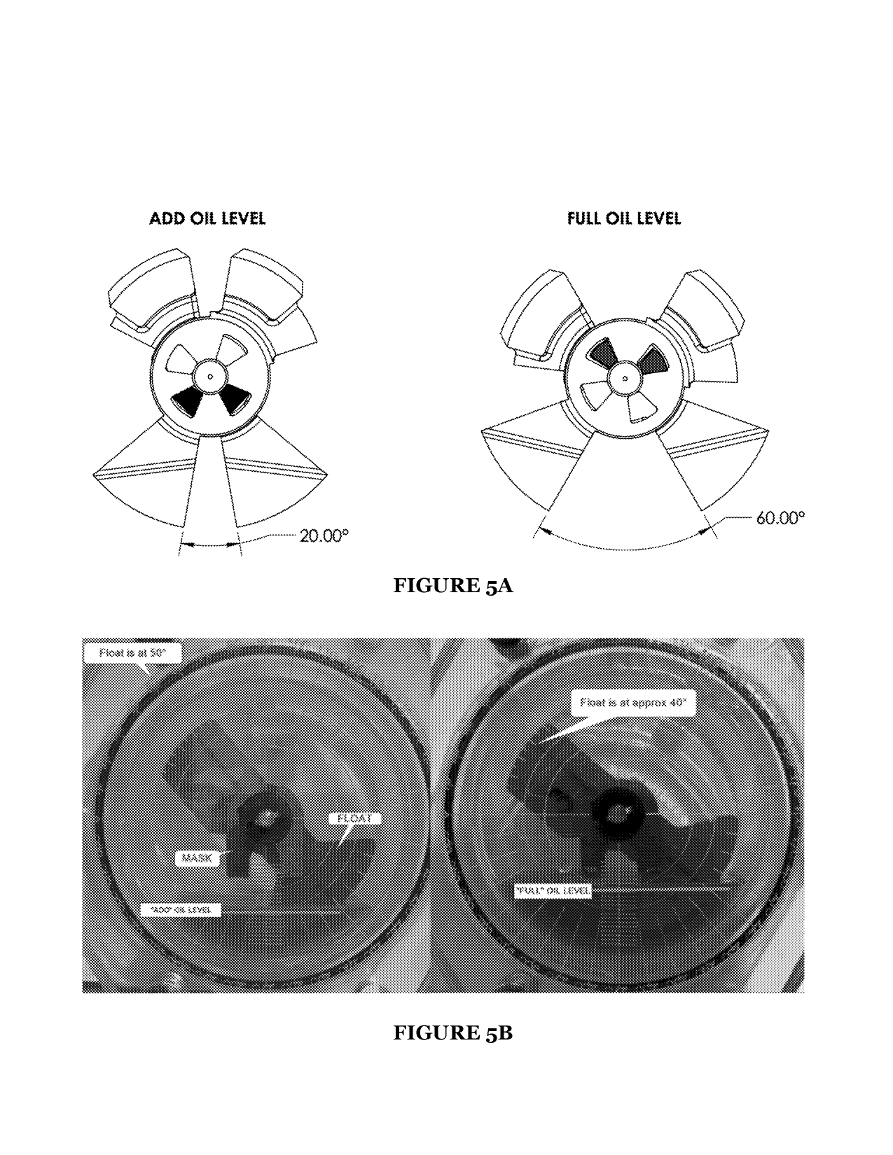

As shown in FIGS. 2D and 2E, the float mechanism can include a first float 211a and optionally, a second float 211b. Each float 211 is preferably a rotating float 211 (e.g., as shown in the example of FIG. 5B), such that a float 211 rotates with the wheel and/or rotates around an axis. Alternatively the float 211 can be a linear float 211 (e.g., a float 211 that moves linearly instead of with rotational motion), a static float, and/or otherwise configured.

In variants where the float mechanism includes multiple floats, the floats can rotate in opposite directions (e.g., such that the first float 211a rotates in a clockwise direction and a second float 211b rotates in a counterclockwise direction). Alternatively, the floats can rotate in the same direction and/or any suitable direction. As such, the second float can about the shaft in the opposite direction of the first float.

The float(s) can be mounted such that moving portions rotate along a fixed path within the housing 100 (e.g., relative to the indicator window 120). Alternatively, the float 211 can be coupled to or within the housing, unmounted, and/or having any other suitable positioning.

The float 211 can define an opening aligned with a central axis of the float 211 (e.g., where the central axis passes through the center of gravity or the center of mass of the float). The central axis can be the same central axis as the hub cap 110 body. Alternatively, the central axis of a float 211 can be different from the central axis of the hub cap 110 body and/or have any other suitable definition.

A characteristic portion of a float 211 can have a radial length substantially equivalent to the radius of the hub cap 110 cover, a predetermined proportion of the hub cap 110 cover radius, and/or any other length (e.g., as in the example shown in FIG. 2A). In variations, the radial length of the float 211 can be slightly less than the radius of the hub cap 110 cover, so as to not interfere with the hub cap 110 cover during motion of the float.

As shown in FIGS. 4A and 4B, the float 211 can include a lobe, which functions to be angularly displaced about the central axis of the float, based upon a level of oil within the oil reservoir. In variations, the lobe 2111 can be in the shape of: an annulus, a semicircle, a trapezoid, a radial segment (e.g., fan-shaped), a combination of shapes, or of another suitable morphology.

In variants, the shape of the lobe 2111 can be selected to maximize the amount of oil that is displaced, while avoiding features of the hub cap 110 or wheel, where features can include one or more of: a spindle, a spindle nut, or another suitable feature.

In variants, the lobe 2111 can be positioned at the bottom portion of the float 211 and in contact with the oil (where “bottom” is defined in relation to a direction of gravity). Alternatively, the lobe 2111 can be positioned at the top of the float 211 and/or at any suitable position relative to the float, oil (where “top” is defined in relation to a direction of gravity)

Each float 211 can include multiple lobes. Alternatively, each float 211 can include only one lobe. In variants where a float 211 includes multiple lobes, the multiple lobes are preferably asymmetric (e.g., asymmetrically positioned, asymmetrically weighted, etc.), but can alternatively be symmetric. In variants, the lobe 2111 asymmetry can be tuned to position the float 211 and the center of gravity of a float, in a manner such that a small buoyant force (e.g., attributed to oil level relative to features of the lobe/float) can move the float 211 in a radial direction to indicate oil level within the oil reservoir.

In variants where the float mechanism includes multiple floats, the floats can be positioned such that the faces of the lobes are coplanar. Alternatively, the floats can be positioned such that the faces of the lobes are non-coplanar, offset, and/or have any other suitable relationship.

As shown in FIGS. 4A and 4B, the float 211 can include a counterweight 2112 positioned opposite the lobe 2111 about the central axis. The counterweight 2112 functions to provide balancing of the float, and to provide a ballast for the weight of the lobe(s) of the float. Additionally or alternatively, the counterweight 2112 can function to ensure proper rotation of the float 211 about the central axis, provide rotational torque needed to move the float, and/or have any other suitable function.

The counterweight 2112 can be positioned at the upper portion of the float 211 (e.g., opposite to the lobe, where “upper” is defined in relation to a direction of gravity). Alternatively, the counterweight 2112 can be positioned at the bottom of the float 211 (where “bottom” is defined in relation to a direction of gravity, adjacent to the lobe, within the center of the float, and/or at any other suitable position within the float. The counterweight 2112 can be positioned radially opposite with respect to the lobe 2111 on the float 211 (e.g., as in the example shown in FIG. 4A). Alternatively, the counterweight 2112 can be positioned offset from the lobe 2111 and/or have any other suitable positioning.

In variations with multiple floats, the first float 211a can include a first lobe, a first counterweight, and a marking 2113, and the second float 211b can include a second lobe, a second counterweight, and a mask 220 defining an opening through which the marking can be observed. In such variations, the indicator subsystem 200 can include a shaft 230 aligned with the central axis, wherein the first float of the float mechanism 210 rotates about the shaft. An example shown in FIG. 3B depicts a shaft 230 with a vent extending through an interior portion of the shaft 230.

In variants, the morphology of a float can additionally or alternatively thus be selected to maximize the amount of oil that is displaced, while avoiding the spindle, spindle nut, and features of the hub cap. When the float 211 includes multiple lobes (e.g., example shown in FIG. 2A), the lobes are preferably radially opposing, but can alternatively be offset. The multiple lobes are preferably asymmetric (e.g., asymmetrically positioned, asymmetrically weighted, etc.), but can alternatively be symmetric. In variants, the lobe 2111 asymmetry can be tuned to position the float 211 and the float's center of gravity, such that a small buoyant force can move the float. The shape of each lobe 2111 can be: a radial segment (e.g., fan-shaped), rectangular, and/or any other shape. The float 211 can be radially stepped (e.g., to allow for clearances), flat, or have any other lengthwise profile. The float 211 can have a radial length substantially equivalent to the radius of the hub cap 110 cover, a predetermined proportion of the hub cap 110 cover radius, and/or any other length. The float 211 can be plastic, metal, composite, and/or any other material. The float 211 pose at rest can be asymmetric (e.g., off vertical by 10°, 20°, 30°, 40°, 50°, 60°, a range bounded by any of the aforementioned values, less than 10°, or more than 60° when empty), symmetric (e.g., aligned with gravity, etc.), and/or otherwise positioned at rest.

### 1.3.2 Float– Marking and Mask aspects

As shown in FIGS. 4A and 4D, the float 211 can include a marking 2113, which functions to indicate the oil level within the oil reservoir, through the indicator window 120, to a user or other observer interacting with the hub cap 110 system.

In variants, the marking 2113 can be or include one or more of: a colored portion (e.g., a series of red and green markings 2113, series of blue and yellow markings 2113, etc.), hash marks, a binary label (e.g., “FULL”, “EMPTY”, etc.), a continuous range of indication markings 2113, protruding markings 2113, recessed markings 2113, optically-detectable markings 2113, or other suitable markings 2113. In the example shown in FIGS. 4A and 4D, the marking 2113 includes a label of a first color (e.g., green) and a label of a second color (e.g., red), where the first color indicates a full or nearly full oil level, and the second color indicates an empty or nearly empty oil level. The first color and the second color can be selected to provide readability in relation to a set of factors including one or more of: level of colorblindness, differentiability with respect to environmental conditions (e.g., daytime, dusk, dawn, nighttime, etc.), susceptibility to degradation in response to environmental stimuli (e.g., UV exposure, etc.), and/or other factors.

As shown in the example of FIGS. 4A-4D, the float mechanism can be radially stepped (e.g., to allow for clearances between multiple floats that are positioned adjacent to each other along the central axis), flat, or have any other lengthwise profile. Radial steps can provide suitable stop positions that define angular displacement limits for each float, in variations of the float mechanism where multiple floats are positioned along the central axis, and where the steps provide co-planar faces of portions of adjacent floats.

The poses of floats of the float mechanism at rest/equilibrium can be asymmetric (e.g., off vertical by 10 degrees, 20 degrees, 30 degrees, 40 degrees, 50 degrees, 60 degrees, a range bounded by any of the aforementioned values, less than 10 degrees, or more than 60 degrees when full), symmetric (e.g., aligned with gravity, etc.), and/or otherwise positioned at rest (e.g., example shown in FIG. 5A). In the example shown in FIG. 5A, the indicator resolution can be significantly more (e.g., double that of) than a system including a single float, However, the float mechanism can be otherwise configured.

As shown in FIGS. 4A and 4D, a float 211 (e.g., second float 211 of a multi-float 211 indicator subsystem) can include a mask 220, which functions to selectively show the marking 2113 (e.g., on the first float, on another object positioned adjacent to the float, etc.) depending on oil level within the oil reservoir. The mask 220 can include an opening (e.g., hole, window, etc.). The mask 220 can provide any number of openings (e.g., 1, 2, 3, 4, etc.). The opening (e.g., radially opposing openings) can allow a section of the float 211 (e.g., first float) to show therethrough (e.g., example shown in FIG. 4D), where the second includes or provides the marking 2113(s) described above. The opening(s) can be configured to reveal the marking 2113 on the float, such that oil level within the oil reservoir can be observed.

The mask 220 can be a separate element (e.g., separate from the float). In one example, the mask 220 can be provided on a second float, and the marking 2113(s) can be provided on a first float. Alternatively, the mask 220 can be defined on the float 211 (e.g., example shown in FIG. 4B).

In variations, the mask 220 can be static (e.g., a separate element which does not rotate or move). Alternatively, the mask 220 can be a non-static/moving element (e.g., such that the mask 220 rotates with respect to the oil level and/or any other suitable forces). In the example shown in FIG. 4B, the mask 220 is an opening into the second float 211 and thus fixed to rotate with the float 211 in response to oil level within the oil reservoir, such that the fill level marking 2113 associated with the first float 211 position shows through the indicator window 120 and through the mask 220 of the second float.

The mask 220 can include an opening aligned with the central axis of the float, where the central axis is defined in relation to an intended rotational axis of a float 211 (as described above), and/or defined in relation to morphological features of the housing, the indicator window 120, or other suitable system elements. As such, the central axis can be the same central axis as the hub cap 110 body. Alternatively, the central axis can be different from the central axis of the hub cap 110 and/or have any other suitable definition.

### 1.3.3 Shaft 230

As shown in FIG. 3B, the system can include a shaft 230, which functions to mount the indicator subsystem 200 to an interior portion of the housing, such that the indicator subsystem 200 is seated within the oil reservoir. The shaft 230 can be mounted rigidly to the housing, more preferably the indicator window 120 (e.g., the window, the base of the neck, etc.), or alternatively can be mounted to another component of the housing. In one variant, the shaft 230 can extend inward along the central interior axis of the housing. However, the shaft 230 can be otherwise arranged.

In variations, the shaft 230 can include a vent extending through an interior portion of the shaft 230 (e.g., above oil level), where the vent is configured to allow for pressure equalization within the hub cap 110 body (e.g., in relation to an amount of oil within the oil reservoir, in relation to an amount of oil used within the oil reservoir, in relation to an amount of oil added to the oil reservoir, in relation to oil reservoir heating and cooling behavior, etc.). Alternatively, the vent can extend through the entire shaft 230 and/or any suitable part of the shaft 230.

The shaft 230 can extend from the housing 100 through the opening of the float. Alternatively, the shaft 230 can only extend through the opening of the float, extend through the mask 220, extend farther into the body of the hub cap, and/or have any other suitable length or positioning.

In variations, the shaft 230 can include a rotational bearing statically connected to the float 211 (e.g., along an outer race). In a first variant, the rotational bearing is mounted onto and rotates about the shaft 230. In a second variant, the rotational bearing is mounted directly into the hub cap 110 window. Alternatively, the float 211 can be slip fit onto the shaft 230 and/or have any other suitable mounting.

The float 211 can be rotatably mounted to the housing 100 by a rotary interface.

In a first variant, the rotary interface can include a shaft 230. The shaft 230 can be mounted rigidly to the housing, more preferably the housing 100 cover (e.g., the window, the base of the neck, etc.), but can alternatively be mounted to another component of the housing. The shaft 230 can extend inward along the housing 100 central axis, but can alternatively be otherwise arranged. The float 211 can be coupled to the shaft 230 via a slip fit, a bearing, and/or otherwise rotatably connected to the shaft 230. Alternatively, the shaft 230 rotates relative to the window, wherein the float 211 is statically mounted to the shaft 230.

In a second variant, the rotary interface can include a rotational bearing statically connected to the float 211 (e.g., along an outer race). In a first embodiment, the rotational bearing can be mounted onto and rotate about the shaft 230. In a second embodiment, the rotational bearing can be mounted directly into the hub cap 110 window.

### 1.4 Mechanical stops

The system can optionally include a mechanical stop 240, which functions to prevent adjacently-positioned floats from entirely overlapping during rotation of each float 211 about the central axis (e.g., shaft 230). In multi-float configurations, the mechanical stop 240 can be positioned between the first and second floats configured to limit the rotational movement of the first and second floats.

In variants, the mechanical stop 240 can be positioned between the counterweights 2112 of different floats. Alternatively, the mechanical stop 240 can be positioned between the lobes of different floats, at another location along the float, and/or at any other suitable position.

The mechanical stop 240 can be a part of the float. Alternatively, the mechanical stop 240 can be a separate element connected to a respective float 211 and/or have any other suitable form.

In examples, the mechanical stop 240 can be: a shoulder body attached to the float 211 (e.g., attached to the lobe 2111 of the float), a protrusion coupled to a float, a magnetic element that provides a force that constrains motion of the float, or other suitable component that constrains a range of motion of the float.

### 1.5 Standoff element

As shown in FIG. 4C, the system can optionally include a standoff element, which functions to provide spacing between multiple floats or between a float 211 and another suitable element.

The standoff element can be arranged on a surface of a float 211 (e.g., example shown in FIG. 4C). Alternatively, the standoff element can be a separate element and/or have any suitable arrangement. For instance, the standoff element 250 can be disposed between the first float 211a and second float 211b in embodiments involving multiple floats. In one such embodiment, the second float 211b is positioned in front of (e.g., toward the indicator window) the first float 211a along the shaft 230.

In examples, the standoff element can be: a set of teeth (e.g., protruding from a surface of a float 211 to create space in front or behind the float), a lip (e.g., a raised edge alone the float), a protrusion, and/or another suitable element that provides standoff functionality.

### 1.6 Weighted indicator

As shown in FIGS. 2A, 2B and 2C, the system can include a weighted indicator 260, which functions to indicate oil level with respect to the marking 2113 on the float.

An example of the weighted indicator 260 is depicted with a weighted arrow, with examples shown in FIGS. 2A, 2B, 2C. The weighted indicator 260 freely rotates relative to the float(s) and the housing 100 and a set of fill level markings 2113 extending arcuately about the float 211 rotational axis. In operation, the float 211 angular position is set by the oil level, and the weighted indicator 260 hangs vertically (e.g., aligned with gravity) and points to a fill level marking 2113 associated with the oil fill level for the respective position.

However, variations of the system can omit a weighted indicator 260.

### 1.7 Additional variations of aspects of the Hub Cap

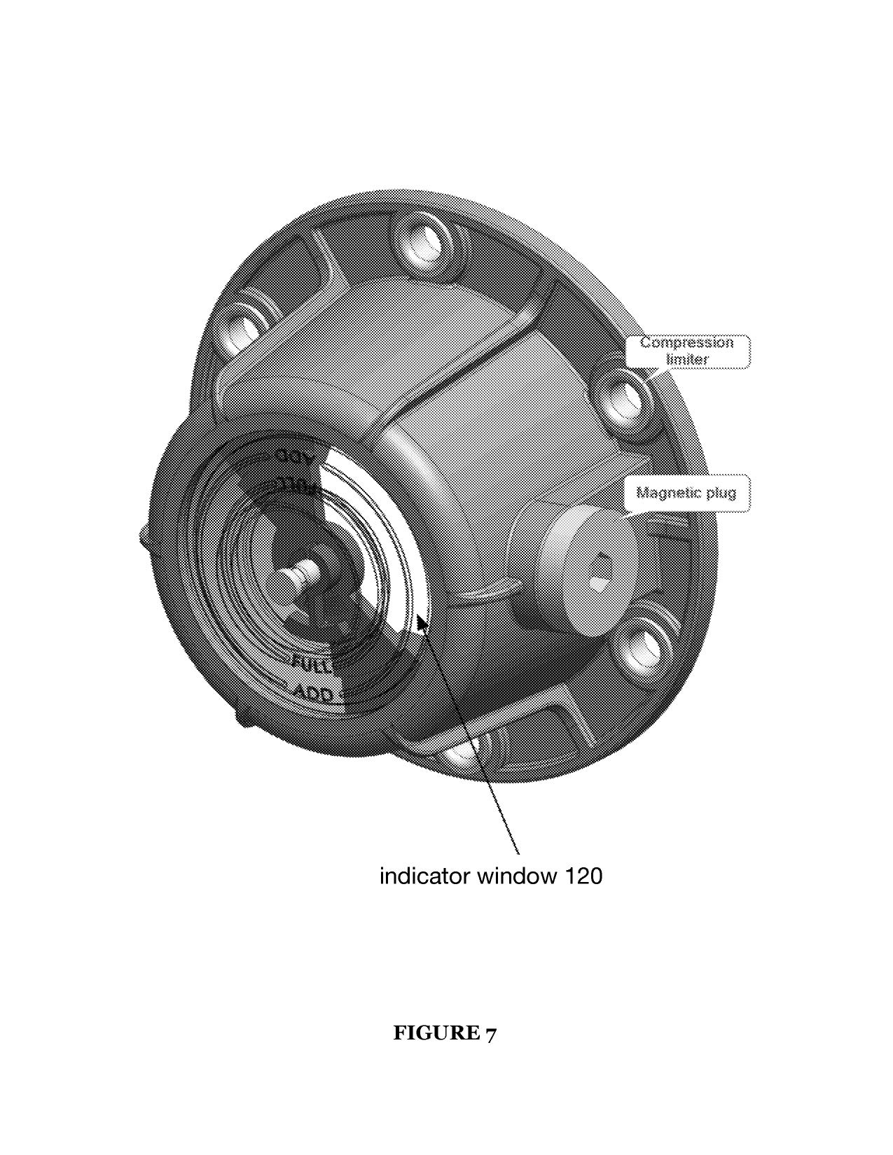

As shown in FIGS. 7, 2A, and 2D, the housing 100 of the hub cap 110 can couple to the wheel 10 with a set of compression limiter features, where the compression limiter features include tubular components (e.g., metal components) inserted into fastening holes of the housing 100 about the circumference of the housing 100, to prevent the housing 100 from cracking or deforming when the hub cap 110 is bolted or screwed onto the wheel 10. Also shown in FIGS. 7 and 2B, the housing 100 of the hub cap 100 can include a magnetic plug for fill hole 30. The magnetic plug can function to capture metallic shavings and debris produced by the friction of moving parts within the hub cap 110 (e.g., within the oil reservoir). By holding these ferrous particles out of circulation, the magnetic plug protects hub cap components from premature wear and damage. Additionally or alternatively, in relation to the venting functions described, the magnetic plug can also function as a vent plug, thereby allowing for proper pressure relief of the hub cap 110, while also collecting debris magnetically.

### 2. Conclusions

Although omitted for conciseness, the preferred embodiments include every combination and permutation of the various system components and the various method processes, wherein the method processes can be performed in any suitable order, sequentially or concurrently.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

Additional or alternative embodiments implement the above methods and/or processing modules in non-transitory computer-readable media, storing computer-readable instructions. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A system comprising:
a hub cap comprising a central axis defining a rotational axis for the system; and
an indicator window comprising an indicator portion overlapping with the central axis.

2. The system of claim 1, further comprising an indicator subsystem comprising:
a float mechanism comprising a first float, wherein the first float comprises a first lobe, a first counterweight, and a marking;
a shaft aligned with the central axis, wherein the first float of the float mechanism rotates about the shaft; and
a mask defining an opening.

3. The system of claim 1, wherein the shaft defines a vent extending through an interior portion of the shaft.

4. The system of claim 1, wherein the indicator subsystem further comprises polarized material configured to selectively block or reveal the marking based on the angular position of the float mechanism.

5. The system of claim 1, wherein the hub cap further comprises a side port configured for oil filling.

6. The system of claim 1, wherein the float mechanism further comprises a second float, wherein the second float comprises a second lobe and second counterweight.

7. The system of claim 6, wherein the mask is defined on the second float.

8. The system of claim 6, wherein the float mechanism further comprises a standoff element disposed between the first and second float.

9. The system of claim 6, wherein the second float is positioned in front of the first float along the shaft.

10. The system of claim 9, wherein the float mechanism further comprises a mechanical stop positioned between the first and second floats configured to limit the rotational movement of the first and second floats.

11. The system of claim 9, wherein the second float rotates about the shaft in the opposite direction of the first float.

12. A system comprising:
a hub cap comprising a central axis defining a rotational axis for the system;
an indicator window comprising an indicator portion coaxially aligned with the central axis; and
an indicator subsystem comprising:
a float mechanism defining an indicator resolution;
a shaft aligned with the central axis, wherein a first float of the float mechanism rotates about the shaft and wherein the first float comprises a first lobe, a first counterweight, and a marking; and
a mask defining an opening.

13. The system of claim 12, wherein the float mechanism comprises a second float, wherein the second float comprises a second lobe and a second counterweight.

14. The system of claim 12, wherein the mask is defined on the second float.

15. The system of claim 12, wherein the second float increases the indicator resolution by at least a factor of 2.

16. The system of claim 12, wherein the first float and the second float rotate about the shaft in opposite directions.

17. The system of claim 12, wherein the first float and second float are positioned along the shaft such that the first lobe and second lobe are coplanar.

18. The system of claim 13, wherein the float mechanism further comprises a standoff element disposed between the first float and the second float.

19. The system of claim 13, wherein the float mechanism further comprises a mechanical stop disposed between the first counterweight and the second counterweight.

20. The system of claim 12, wherein the first float and the second float further comprise polarized material configured to selectively block or reveal underlying indicia based on the angular position of the float mechanism.
